(19) United States
(12) Patent Application Publication
(10) Pub. No.: US 2019/0313850 A1
(43) Pub. Date: Oct. 17, 2019

(54) SMOKELESS COOKING APPARATUS

(71) Applicant: douglas Mettlach, Wheat Ridge, CO (US)

(72) Inventor: douglas Mettlach, Wheat Ridge, CO (US)

(21) Appl. No.: 16/383,611

(22) Filed: Apr. 14, 2019

Related U.S. Application Data
(60) Provisional application No. 62/657,782, filed on Apr. 14, 2018.

(51) Int. Cl. A47J 37/07

(52) U.S. Cl. CPC A47J 37/0713; A47J 37/0763; A47J 37/0786

(57) ABSTRACT

According to some embodiments, a smokeless cooking apparatus is disclosed. The smokeless cooking apparatus may include an oven configured for the processing of a food substance. Further, the oven may include a thermally insulated enclosure configured to trap heat for the processing of the food substance. Further, the oven may include an oven base plate configured to accommodate a secondary fuel container. Further, the oven may include a plurality of racks configured to receive the food substance to be processed. Further, the oven may include a closable opening configured to provide access to an interior of the oven in an open state. Further, the oven may include the secondary fuel container configured to accommodate the secondary fuel. Further, the oven may include a chimney. Further, the smokeless cooking apparatus may include a burner. Further, the smokeless cooking apparatus may include a primary fuel container.

### RELATED APPLICATION(S)

Under provisions of 35 U.S.C. § 119e, the Applicant(s) claim the benefit of U.S. provisional application No. 62/657,782, filed on 14 Apr. 2018, which is incorporated herein by reference.

### FIELD OF THE INVENTION

The invention relates generally to outdoor cooking equipment and utensils, and in particular to a smokeless cooking apparatus.

### BACKGROUND OF THE INVENTION

For millions of back yard barbecue enthusiasts, the use of mesquite or hickory wood chips in a charcoal grill has become the secret ingredient. This practice infuses a rich, smoky flavor into the meat and produces a very satisfactory result. Unfortunately, for those who prefer propane grills, or whose local ordinances or homeowners' agreements forbid them from using charcoal, this option is unavailable. Various devices have been developed to add smoke from wood chips to a conventional propane grill, but each has proven to be less than satisfactory in its own way, and some have even created a fire hazard. If a safe and effective device could be developed which complies with any local bans on charcoal and successfully infuses grilled meat with the smoke from wood chips, such a device would be useful and would be well received.

Therefore, there is a need for an improved smokeless cooking apparatus that may overcome one or more of the above-mentioned problems and/or limitations.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a smokeless cooking apparatus is disclosed. The smokeless cooking apparatus may include an oven configured for the processing of a food substance. Further, the oven may include a thermally insulated enclosure including at least one side wall, and a top wall. Further, the thermally insulated enclosure may be configured to trap heat for the processing of the food substance. Further, the oven may include an oven base plate configured to accommodate a secondary fuel container. Further, the oven base plate may be configured to heat the secondary fuel container, to heat up and ignite a secondary fuel placed in the secondary fuel container. Further, the oven may include a plurality of racks, including rack, rack, and rack. Further, the plurality of racks may be removably incorporated inside the thermally insulated enclosure of the oven. Further, the plurality of racks may be configured to receive the food substance to be processed. Further, the oven may include a closable opening. Further, the closable opening corresponds to a wall of the at least one side wall. Further, the closable opening may be configured to provide access to an interior of the oven in an open state. Further, the closable opening may be configured to thermally insulate the thermally insulated enclosure when in a closed state. Further, the oven may include the secondary fuel container configured to accommodate the secondary fuel. Further, the secondary fuel container may be shaped in a manner consistent with the oven base plate. Further, the secondary fuel container may be configured to receive heat through the oven base plate through conduction. Further, the secondary fuel, upon being ignited may produce heat and smoke. Further, the smoke may aid in the processing of the food substance. Further, the oven may include a chimney located on a side wall of the oven. Further, the chimney may be configured to provide an outlet for excess heat and smoke in the oven. Further, the smokeless cooking apparatus may include a burner configured to produce a flame through combustion of a primary fuel and provide heat to the oven to heat the oven base plate, and subsequently the secondary fuel container. Further, the secondary fuel container may be configured to provide heat to the secondary fuel through conduction and ignite the secondary fuel placed in the secondary fuel container. Further, the smokeless cooking apparatus may include a primary fuel container configured to store the primary fuel and transmit the primary fuel to the burner via a fuel transfer duct.

According to some embodiments, a smokeless cooking apparatus is disclosed. Further, the smokeless cooking apparatus may include an oven configured for the processing of a food substance. Further, the oven may include a thermally insulated enclosure including at least one side wall, and a top wall. Further, the thermally insulated enclosure may be configured to trap heat for the processing of the food substance. Further, the oven may include an oven base plate configured to accommodate a secondary fuel container. Further, the oven base plate may be configured to heat the secondary fuel container, to heat up and ignite a secondary fuel placed in the secondary fuel container. Further, the oven may include a plurality of racks, including rack, rack, and rack. Further, the plurality of racks may be removably incorporated inside the thermally insulated enclosure of the oven. Further, the plurality of racks may be configured to receive the food substance to be processed. Further, the oven may include a closable opening. Further, the closable opening may correspond to a wall of the at least one side wall. Further, the closable opening may be configured to provide access to an interior of the oven in an open state. Further, the closable opening may be configured to thermally insulate the thermally insulated enclosure when in a closed state. Further, the oven may include the secondary fuel container configured to accommodate the secondary fuel. Further, the secondary fuel container may be shaped in a manner consistent with the oven base plate. Further, the secondary fuel container may be configured to receive heat through the oven base plate through conduction. Further, the secondary fuel, upon being ignited may produce heat and smoke. Further, the smoke may aid in the processing of the food substance. Further, the oven may include a chimney located on a side wall of the oven. Further, the chimney may be configured to provide an outlet for excess heat and smoke in the oven. Further, the smokeless cooking apparatus may include a plurality of burners, including a first burner, a second burner, and a third burner configured to produce a flame through combustion of a primary fuel and provide heat to the oven to heat the oven base plate, and subsequently the secondary fuel container. Further, the secondary fuel container may be configured to provide heat to the secondary fuel through conduction and ignite the secondary fuel placed in the secondary fuel container. Further, the smokeless cooking apparatus may include a primary fuel container configured to store the primary fuel, and transmit the primary fuel to the first burner, the second burner, and the third burner via a plurality of fuel transfer ducts including an input fuel transfer duct, first duct, a second duct, and a third duct.

Further, in some embodiments, the smokeless cooking apparatus may include a thermostat controller configured to regulate a temperature inside the oven. Further, the thermostat controller may include a temperature bulb (not shown) mounted inside the oven configured to detect a temperature in the interior of the oven. Further, the thermostat controller may include a primary fuel input. Further, the primary fuel input may include an inlet configured to receive the input fuel transfer duct from the primary fuel container.

Further, the thermostat controller may include a primary fuel output. Further, the primary fuel output may include an outlet connected to the plurality of fuel transfer ducts to the plurality of burners configured to transmit the primary fuel from the thermostat to the burner. Further, the thermostat controller may include an output valve (not shown) connected to the primary fuel output. Further, the output valve may be configured to restrict and allow the primary fuel to be transmitted to the burner from the thermostat based on a magnitude of opening of the output valve. Further, the output valve may restrict all transmission of the primary fuel to the burner in a completely closed state. Further, the output valve may allow all transmission of the primary fuel to the burner in a completely open state. Further, the thermostat controller may include a controller (not shown) connected to the temperature bulb and the outlet valve. Further, the controller may be configured to regulate an amount of the primary fuel transmitted to the burner from the thermostat by changing the magnitude of opening of the output valve. Further, the thermostat controller may include a regulator connected to the temperature bulb and the controller, wherein the regulator may be configured to be manipulated by a user and adjust a temperature in the interior of the oven.

Further, the smokeless cooking apparatus may include a transport mechanism configured to transport the smokeless cooking apparatus including the oven, the burner, and the primary fuel container, Further, the transport mechanism may include a frame. Further, the frame may include a generally rectangular bottom plate. Further, the frame may include four posts, including a first post, second post, third post, and a fourth post vertically extending from four corners of the bottom plate. Further, the bottom plate may provide structural stability to the frame. Further, the bottom plate may be configured to accommodate the primary fuel container. Further, the four posts may each include a support mechanism, such as a first mechanism of the first post configured to receive the oven. Further, the support mechanism of each of the four posts may be configured to support the oven. Further, the transport mechanism may include a top plate located parallel upwards from the bottom plate near a top corner of the four posts. Further, the top plate may be shaped in a congruent manner with the bottom plate. Further, the top plate may be configured to accommodate the plurality of burners.

Further, the transport mechanism may include a plurality of wheels, such as a first wheel, and a second wheel connected to the bottom plate. Further, the plurality of wheels may be configured to allow easy movement of the transport mechanism. Further, the transport mechanism may include a plurality of casters, such as a first caster connected to the bottom plate. Further, the plurality of casters may be configured to allow easy turning of the transport mechanism.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front view of a smokeless cooking apparatus, in accordance with some embodiments.

FIG. 2 is a front view of a smokeless cooking apparatus including a thermostat controller, in accordance with some embodiments.

FIG. 3 is a perspective view of a smokeless cooking apparatus including a plurality of burners, in accordance with some embodiments.

FIG. 4 is a perspective view of a smokeless cooking apparatus including a hinged door, in accordance with some embodiments.

FIG. 5 is a perspective view of a smokeless cooking apparatus including a transport mechanism, in accordance with some embodiments.

FIG. 6 is a perspective view of a smokeless cooking apparatus including a transport mechanism, a thermostat controller, in accordance with some embodiments.

FIG. 7 is a back view of a smokeless cooking apparatus, in accordance with some embodiments.

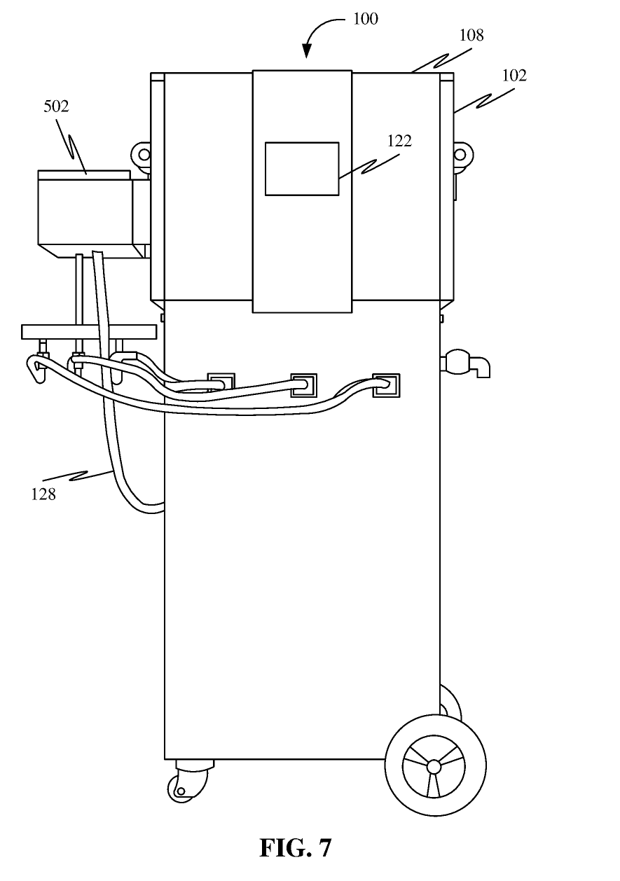

FIG. 8 is a right side view of a smokeless cooking apparatus, in accordance with some embodiments.

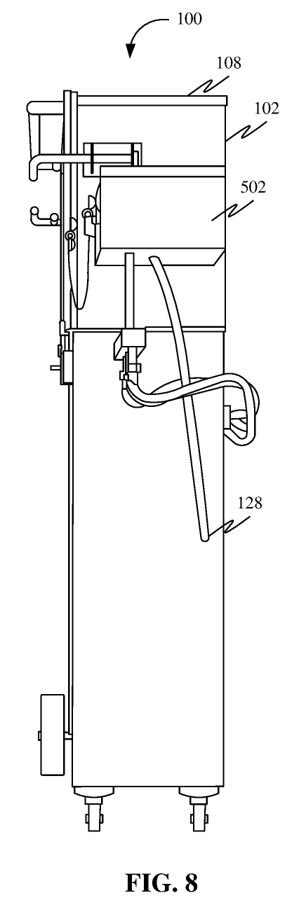

FIG. 9 is a left side perspective view of a smokeless cooking apparatus, in accordance with some embodiments.

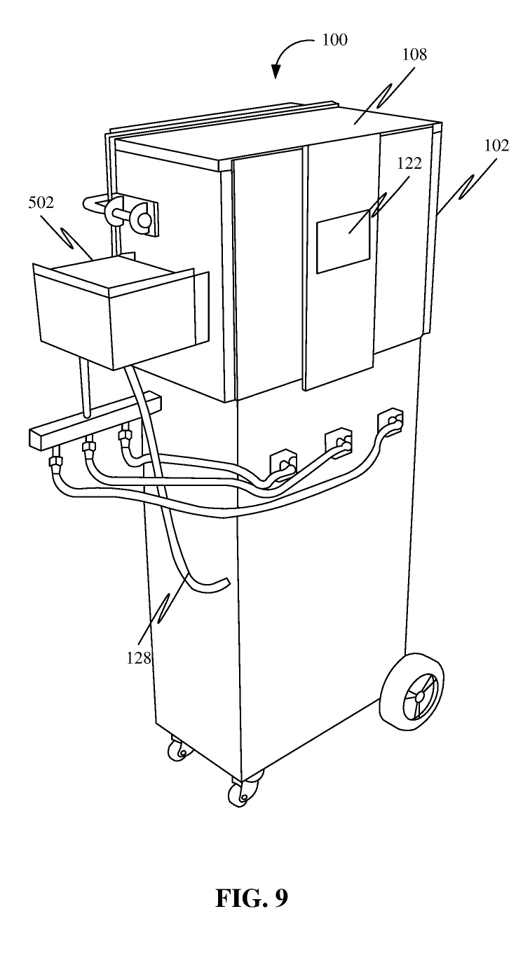

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a smokeless cooking apparatus, embodiments of the present disclosure are not limited to use only in this context.

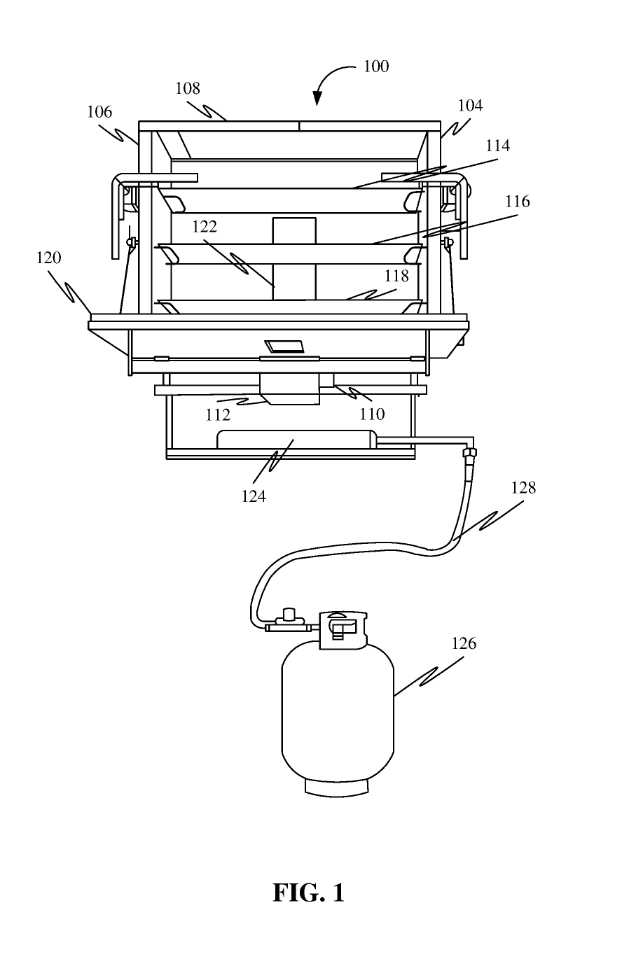

FIG. 1 is a smokeless cooking apparatus 100, in accordance with some embodiments. Further, the smokeless cooking apparatus 100 may include an oven 102 configured for the processing of a food substance. Further, the oven 102 may include a thermally insulated enclosure 104 including at least one side wall 106, and a top wall 108. Further, the thermally insulated enclosure 104 may be configured to trap heat for the processing of the food substance. Further, the oven 102 may include an oven base plate 110 configured to accommodate a secondary fuel container 112. Further, the oven 102 may include a plurality of racks, including rack 114, rack 116, and rack 118. Further, the plurality of racks may be removably incorporated inside the thermally insulated enclosure 104 of the oven 102. Further, the plurality of racks may be configured to receive the food substance to be processed. Further, the oven 102 may include a closable opening 120. Further, the closable opening 120 may correspond to a wall of the at least one side wall. Further, the closable opening 120 may be configured to provide access to an interior of the oven 102 in an open state. Further, the closable opening 120 may be configured to thermally insulate the thermally insulated enclosure 104 when in a closed state. Further, the oven 102 may include the secondary fuel container 112 configured to accommodate the secondary fuel. Further, the secondary fuel container 112 may be shaped in a manner consistent with the oven base plate 110. Further, the secondary fuel container 112 may be configured to receive heat through a burner 124. Further, the secondary fuel container 112 may be configured to heat and ignite the secondary fuel. Further, the secondary fuel, upon being ignited may produce heat and smoke. Further, the smoke may aid in the processing of the food substance. Further, the oven 102 may include a chimney 122 located on at least one side wall of the oven 102. Further, the chimney 122 may be configured to provide an outlet for excess heat and smoke in the oven 102. Further, the smokeless cooking apparatus 100 may include the burner 124 configured to produce a flame through combustion of a primary fuel and heat the secondary fuel container 112. Further, the smokeless cooking apparatus 100 may include a primary fuel container 126 configured to store the primary fuel, and transmit the primary fuel to the burner 124 via a fuel transfer duct 128.

Further, in some embodiments, the processing of the food substance may include at least one of heating, baking, drying, cooking, grilling, and infusing with flavor.

Further, in some embodiments, the primary fuel may include at least one of propane, Liquefied Petroleum Gas (LPG) including butane and isobutane, and natural gas.

Further, in some embodiments, the secondary fuel may include at least one of charcoal briquettes, hardwood lump charcoal, wood chips, and wood pellets.

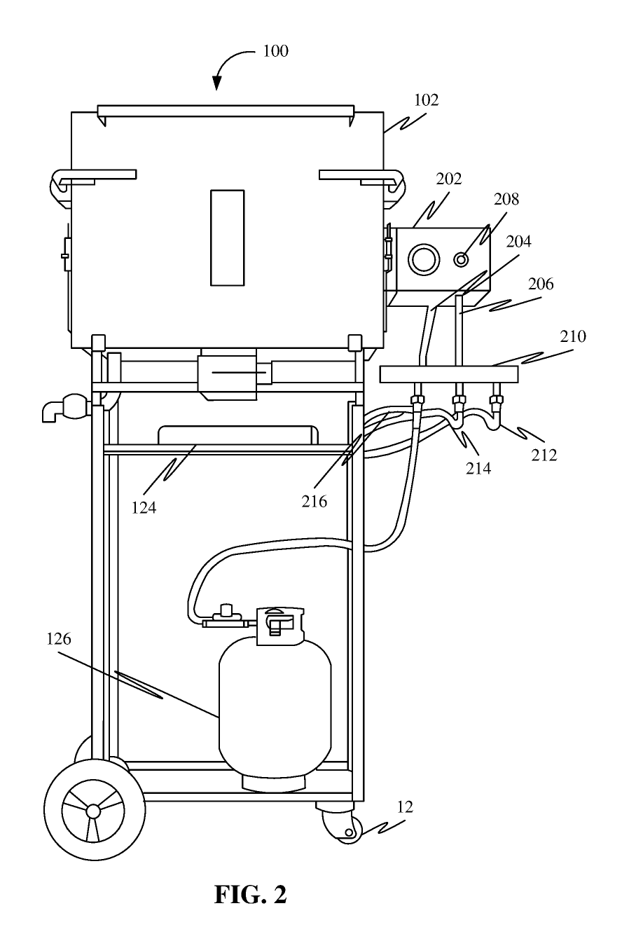

Further, in some embodiments, as shown in FIG. 2, the smokeless cooking apparatus may include a thermostat controller 202 configured to regulate a temperature inside the oven 102. Further, the thermostat controller 202 may be connected to an exterior surface of the at least one side wall. Further, the thermostat controller 202 may include a temperature bulb (not shown) mounted inside the oven 102 configured to detect a temperature in the interior of the oven 102. Further, the thermostat controller 202 may include a primary fuel input 204. Further, the primary fuel input 204 may include an inlet configured to receive the fuel transfer duct 128 from the primary fuel container 126.

Further, the thermostat controller 202 may include a primary fuel output 206. Further, the primary fuel output 206 may include an outlet duct to a fuel transfer chamber 210. Further, the fuel transfer chamber 210 may transfer the primary fuel to the burner 124 via one or more fuel burner input ducts, such as a first fuel burner input duct 212, a second burner input duct 214, and a third fuel burner input duct 216. Further, the thermostat controller 202 may include an output valve (not shown) connected to the primary fuel output 206. Further, the output valve may be configured to restrict and allow the primary fuel to be transmitted to the burner 124 from the thermostat based on a magnitude of opening of the output valve. Further, the output valve may restrict transmission of the primary fuel to the burner 124 in a completely closed state. Further, the output valve may allow maximum transmission of the primary fuel to the burner 124 in a completely open state. Further, the thermostat controller 202 may include a controller (not shown) connected to the temperature bulb and the outlet valve. Further, the controller may be configured to regulate an amount of the primary fuel transmitted to the burner 124 from the thermostat by changing the magnitude of the opening of the output valve. Further, the thermostat controller 202 may include a regulator 208 connected to the temperature bulb and the controller. Further, the regulator 208 may be configured to be manipulated by a user and adjust a temperature in the interior of the oven 102.

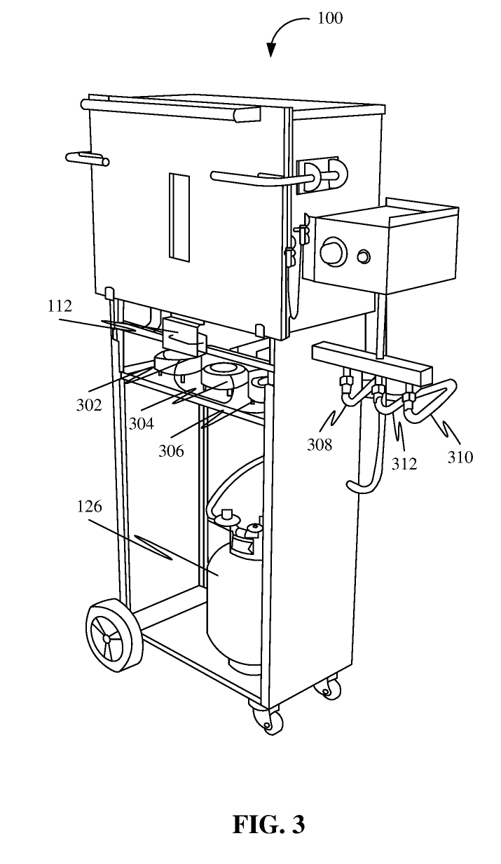

Further, in some embodiments, as shown in FIG. 3 the burner 124 may include a plurality of burners, such as a left side burner 302, a right side burner 306, and a central burner 304. Further, the central burner 304 of the plurality of burners may be located directly beneath the secondary fuel container 112 to heat the secondary fuel container 112 efficiently.

Further, in some embodiments, as shown in FIG. 3, the primary fuel container 126 may be configured transmit the primary fuel to the plurality of burners via a plurality of fuel transfer ducts corresponding to the plurality of burners. For instance, a first fuel transfer duct 308 may transmit the primary fuel to the left side burner 302, a right fuel transfer duct 310 may transmit the primary fuel to the to the right side burner 306. Further, a central fuel transfer duct 312 may transmit the primary fuel to the central burner 304.

Further, in some embodiments, the primary fuel container 126 may include a positive pressure container configured to store the primary fuel at a positive pressure higher than atmospheric pressure to transmit the primary fuel to the burner 124.

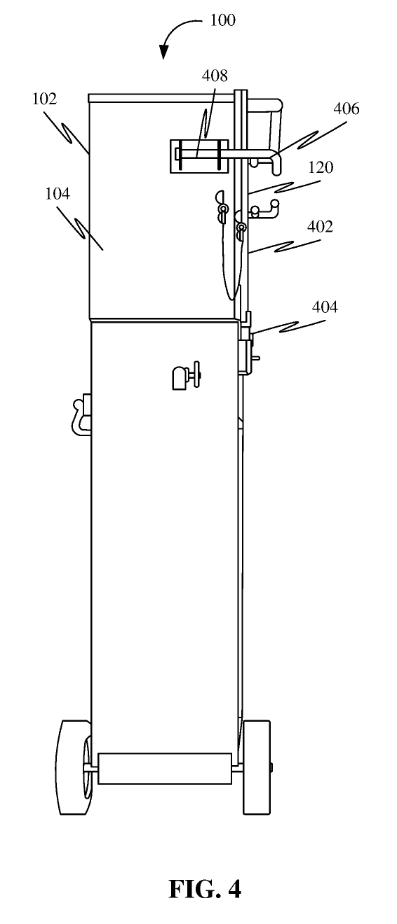

Further, in some embodiments, as shown in FIG. 4, the closable opening 120 may include a hinged door 402. Further, the hinged door may be connected to the oven 102 through a hinge 404. Further, the hinged door 402 may be configured to rotate around an axis of rotation coinciding with the hinge 404. Further, the hinged door 402 may be configured to provide access to the oven 102. Further, the hinged door 402 may be configured to thermally insulate the thermally insulated enclosure 104 when in a closed state. Further, the hinged door 402 may include a locking mechanism, such as a latch 406 and a latch receiver 408 configured to lock the hinged door 402 when in the closed state.

Further, in an embodiment, the closable opening 120 may include a sliding door. Further, the sliding door may be connected to the oven 102 and configured to be accommodated in a plurality of sliding rails built into the top wall, and the bottom panel of the oven 102. Further, the sliding door may be configured to slide in the sliding rails. Further, the sliding door may be configured to provide access to the oven 102. Further, the sliding door may be configured to thermally insulate the thermally insulated enclosure 104 when in a closed state.

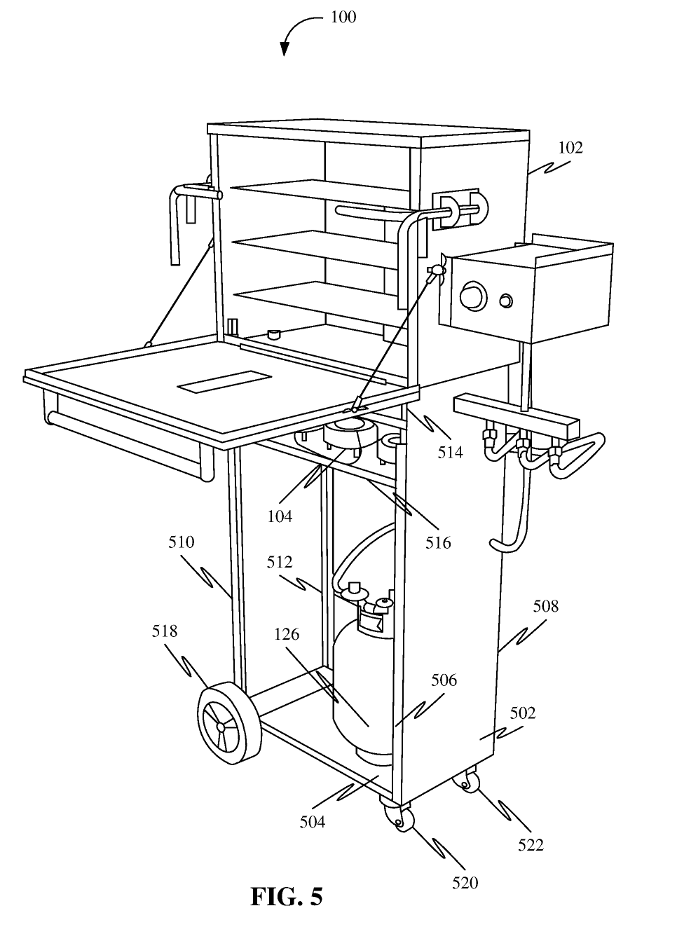

Further, in some embodiments, as shown in FIG. 5 the smokeless cooking apparatus may include a transport mechanism configured to transport the smokeless cooking apparatus including the oven 102, the burner 124, and the primary fuel container 126. Further, the transport mechanism may include a frame 502. Further, the frame may include a generally rectangular bottom plate 504. Further, the frame may include four posts, including a first post 506, a second post 508, a third post 510, and a fourth post 512 vertically extending from four corners of the bottom plate 504. Further, the bottom plate 504 may provide structural stability to the frame 502. Further, the bottom plate 504 may be configured to support the primary fuel container 126. Further, the each of the four posts may include a support mechanism, such as a first mechanism 514 of the first post 506 configured to support the oven 102. Further, the transport mechanism may include a top plate 516 located above the bottom plate 504, below the oven 102 and supported by the four posts. Further, the top plate 516 may be parallel to the bottom plate 504. Further, the top plate 516 may be configured to accommodate the burner 124.

Further, the transport mechanism may include a plurality of wheels, such as a first wheel 518 connected to the bottom plate 504. Further, the plurality of wheels may be configured to allow easy movement of the transport mechanism. Further, the transport mechanism may include a plurality of casters, such as a first caster 520, and a second caster 522 connected to the bottom plate 504. Further, the plurality of casters may be configured to allow easy turning of the transport mechanism.

Further, in some embodiments, the transport mechanism may include a handling mechanism. Further, the handling mechanism may include a plurality of gripping members attached to the four posts. Further, the plurality of gripping members may allow for easy manipulation and transport of the transport mechanism.

Further, in some embodiments, the transport mechanism may include an engine. Further, the engine may be configured to drive at least one wheel of the plurality of wheels. Further, the engine may include at least one of an electric engine and an Internal Combustion engine.

Further, in some embodiments, the secondary fuel container 112 may be positioned below the oven base plate 110 and above the burner 124. Further, the oven base plate 110 may include a base opening shaped consistently with a top opening of the secondary fuel container 112. Further, the base opening may be configured to receive a top opening of the secondary fuel container 112 to receive heat and smoke upon ignition of the secondary fuel.

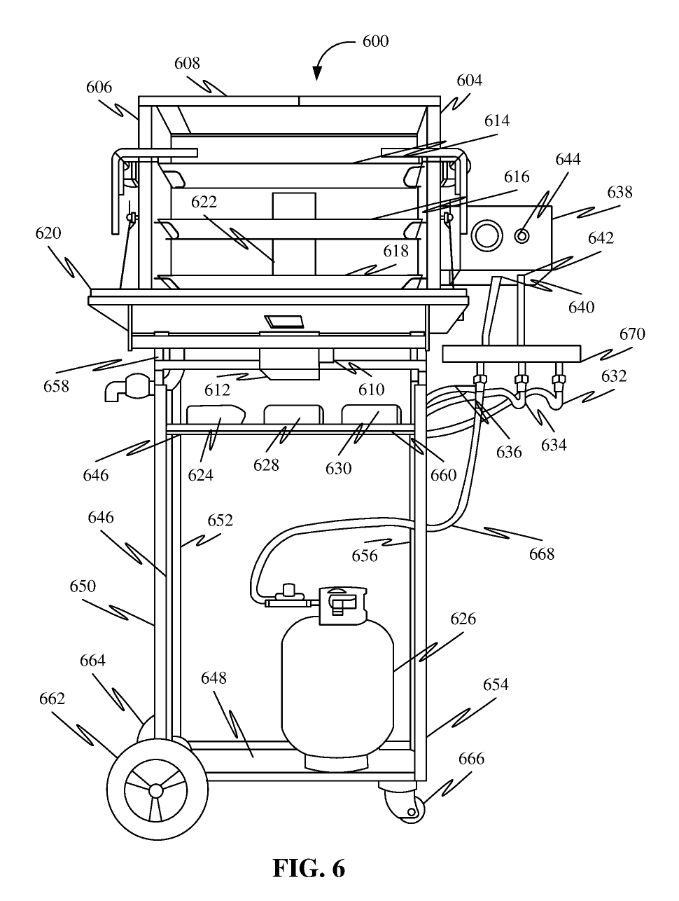

FIG. 6 is a smokeless cooking apparatus 600, in accordance with some embodiments. Further, the smokeless cooking apparatus 600 may include an oven 602 configured for the processing of a food substance. Further, the oven 602 may include a thermally insulated enclosure 604 including at least one side wall 606, and a top wall 608. Further, the thermally insulated enclosure 604 may be configured to trap heat for the processing of the food substance. Further, the oven 602 may include an oven base plate 610 configured to accommodate a secondary fuel container 612. Further, the oven 602 may include a plurality of racks, including rack 614, rack 616, and rack 618. Further, the plurality of racks may be removably incorporated inside the thermally insulated enclosure 604 of the oven 602. Further, the plurality of racks may be configured to receive the food substance to be processed. Further, the oven 602 may include a closable opening 620. Further, the closable opening 620 may correspond to a wall of the at least one side wall. Further, the closable opening 620 may be configured to provide access to an interior of the oven 602 in an open state. Further, the closable opening 620 may be configured to thermally insulate the thermally insulated enclosure 604 when in a closed state. Further, the oven 602 may include the secondary fuel container 612 configured to accommodate the secondary fuel. Further, the secondary fuel container 612 may be shaped in a manner consistent with the oven base plate 610. Further, the secondary fuel container 612 may be configured to receive heat through a plurality of burners. Further, the secondary fuel container 612 may be configured to heat and ignite the secondary fuel. Further, the secondary fuel, upon being ignited may produce heat and smoke. Further, the smoke may aid in the processing of the food substance. Further, the oven 602 may include a chimney 622 located on at least one side wall of the oven 602. Further, the chimney 622 may be configured to provide an outlet for excess heat and smoke in the oven 602. Further, the smokeless cooking apparatus 600 may include the plurality of burners, including a first burner 624, a second burner 628, and a third burner 630 configured to produce a flame through combustion of a primary fuel and provide heat to the secondary fuel container 612. Further, the smokeless cooking apparatus 600 may include a primary fuel container 626 configured to store the primary fuel, and transmit the primary fuel to the first burner 624, the second burner 628, and the third burner 630 via an input fuel transfer duct 668.

Further, in some embodiments, the smokeless cooking apparatus may include a thermostat controller 638 configured to regulate a temperature inside the oven 602. Further, the thermostat controller 638 may be connected to an exterior surface of the at least one side wall. Further, the thermostat controller 638 may include a temperature bulb (not shown) mounted inside the oven 602 configured to detect a temperature in the interior of the oven 602. Further, the thermostat controller 638 may include a primary fuel input 640. Further, the primary fuel input 640 may include an inlet configured to receive the input fuel transfer duct 668 from the primary fuel container 626.

Further, the thermostat controller 638 may include a primary fuel output 642. Further, the primary fuel output 642 may include an outlet duct connected to a fuel transfer chamber 670. Further, the fuel transfer chamber 670 may be configured to transfer the primary fuel to the plurality of burners through a plurality of fuel transfer ducts, such as, a first duct 632, a second duct 634, and a third duct 636.

Further, the thermostat controller 638 may include an output valve (not shown) connected to the primary fuel output 642. Further, the output valve may be configured to restrict and allow the primary fuel to be transmitted to the plurality of burners from the thermostat based on a magnitude of an opening of the output valve. Further, the output valve may restrict transmission of the primary fuel to the plurality of burners in a completely closed state. Further, the output valve may allow maximum transmission of the primary fuel to the plurality of burners in a completely open state. Further, the thermostat controller 638 may include a controller (not shown) connected to the temperature bulb and the outlet valve. Further, the controller may be configured to regulate an amount of the primary fuel transmitted to the plurality of burners from the thermostat by changing the magnitude of the opening of the output valve. Further, the thermostat controller 638 may include a regulator 644 connected to the temperature bulb and the controller, wherein the regulator 644 may be configured to be manipulated by a user and adjust a temperature in the interior of the oven 602.

Further, the smokeless cooking apparatus may include a transport mechanism configured to transport the smokeless cooking apparatus including the oven 602, the plurality of burners, and the primary fuel container 626, Further, the transport mechanism may include a frame 646. Further, the frame may include a generally rectangular bottom plate 648. Further, the frame may include four posts, including a first post 650, a second post 652, a third post 654, and a fourth post 656 vertically extending from four corners of the bottom plate 648. Further, the bottom plate 648 may provide structural stability to the frame 646. Further, the bottom plate 648 may be configured to support the primary fuel container 626. Further, each of the four posts may include a support mechanism, such as a first mechanism 658 of the first post 650, configured to support the oven 602. Further, the transport mechanism may include a top plate 660 located above the bottom plate 648, below the oven 602, and supported by the four posts. Further, the top plate may be parallel to bottom plate 648. Further, the top plate 660 may be configured to accommodate the plurality of burners.

Further, the transport mechanism may include a plurality of wheels, such as a first wheel 662, and a second wheel 664 connected to the bottom plate 648. Further, the plurality of wheels may be configured to allow easy movement of the transport mechanism. Further, the transport mechanism may include a plurality of casters, such as a first caster 666 connected to the bottom plate 648. Further, the plurality of casters may be configured to allow easy turning of the transport mechanism.

Further, in some embodiments, the processing of the food substance may include at least one of heating, baking, drying, cooking, grilling, and infusing with flavor.

Further, in some embodiments, the primary fuel may include at least one of propane, Liquefied Petroleum Gas (LPG) including butane and isobutane, and natural gas.

Further, in some embodiments, the secondary fuel may include at least one of charcoal briquettes, hardwood lump charcoal, wood chips, and wood pellets.

Further, in some embodiments, the primary fuel container 626 may comprise a positive pressure container configured to store the primary fuel at a positive pressure higher than atmospheric pressure to transmit the primary fuel to the plurality of burners.

Further, in some embodiments, the closable opening 620 may include a hinged door. Further, the hinged door may be connected to the oven through a hinge. Further, the hinged door may be configured to rotate around an axis of rotation coinciding with the hinge. Further, the hinged door may be configured to provide access to the oven. Further, the hinged door may be configured to thermally insulate the thermally insulated enclosure when in the closed state.

Further, according to some embodiments, a smokeless cooking apparatus is disclosed, such as the smokeless cooking apparatus 600.

A first exemplary embodiment may be comprised of the smokeless cooking apparatus 600 which includes an oven 602 with a plurality of internal racks, including rack 614, rack 616, and rack 618, and a hinged door, such as the closable opening 620. The oven 602 is mounted on top of a cart, such as the transport mechanism, including casters, such as the caster 666 at a front end, and two wheels, such as the first wheel 662, and the second wheel 664 at a rear end. The smokeless cooking apparatus 600 further provides includes a wood chip burner, such as the secondary fuel container 612 mounted in the center of an oven bottom plate, such as the oven base plate 610.

During cooking process, smoke from burning wood chips in the wood chip burner may be gently circulated throughout the oven 602. A propane burner heat side of the smokeless cooking apparatus may be separated from an oven cook/smoke side by the oven bottom plate to prevent any propane taste from being introduced to a food product being processed or cooked.

A propane tank, such as the primary fuel container 626 may provide fuel via propane lines, such as the fuel transfer duct 668, the first duct 632, the second duct 634, and the third duct 636 to a plurality of burners, such as the first burner 624, the second burner 628, and the third burner 630 which heat the oven 602, as well as the wood chip burner. The process of conduction and convection may gently circulate smoke from the wood chip burner throughout the interior of the oven 602, infusing any meat cooking therein with a smoky flavor. Any moisture dripping from the meat may be flashed off as a vapor within the oven 602, keeping the meat moist and tender. Further, controls, including a thermostat controller, such as the thermostat controller 638, a timer, and a battery-powered electric starter for the plurality of burners.

To use the first exemplary embodiment, a user may place meat on one or more of the racks in the oven 602, and close the hinged door. At startup of the smokeless cooking apparatus 600, the user may put wood chips in the wood chip burner, and light the burners. A center burner of the plurality of burners may heat a bottom of the wood chip burner. Heat conduction may act on the wood chips, and the wood chips may start smoldering. Further, smoke and air temperature in the wood chip burner may be at a higher temperature, and convection may make the smoke rise up a smoke chimney into the oven 602. The smoke in the oven 602 may swirl around depositing a smoky flavor.

Further, the air and smoke mixture may leave the oven out of a chimney, such as the chimney 622. Further, the smoke and air mixture may be replaced through smoke return lines, which may be installed out of any direct heat from the burners and are cooled by ambient air. Hot smoky air may rise out the chimney, cooler oven air may return to the wood chip burner through the smoke return lines in a slow constant circulation that may continue throughout cooking.

Further, the plurality of burners may heat the bottom plate, and conduction may heat an interior of the oven 602. The exhaust heat from the burners may travel to the back of the oven 602 and through a passage and may enter the chimney. Further, exhaust heat traveling up the burner chimney may help heat back the oven 602.

Further, heat rising in the chimney may promote the air rising in the chimney by conduction of heat through the oven back wall. Further, the burners may be controlled by the thermostat controller.

The thermostat controller may include a remote temperature bulb that mounted inside the oven 602 that may detect a temperature of the oven. The temperature may be used by the thermostat controller to modulate a flame of the plurality of burners to maintain a set temperature inside the oven 602.

Further, the component of the smokeless cooking apparatus 600, including the oven, the plurality of racks, the plurality of burners, the chimney, and the wood chip burner, may be manufactured from rigid, durable materials which are heat resistant, such as steel, aluminum alloy, and ceramics. Further, the plurality of casters and the plurality of wheels may be manufactured from a rigid, durable material such as steel or aluminum alloy, providing solid tires which may be manufactured from a flexible, durable material such as rubber. Further, the propane lines may be are manufactured from a flexible, durable material rated for propane use, such as braided stainless steel.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

Although the invention has been explained in relation to its preferred embodiment, it is to be understood that many other possible modifications and variations can be made without departing from the spirit and scope of the invention.

What is claimed is:

1. A smokeless cooking apparatus comprising:
an oven configured for processing of a food substance, the oven comprising:
a thermally insulated enclosure comprised of at least one side wall, and a top wall, wherein the thermally insulated enclosure is configured to trap heat for processing of a food substance;
an oven base plate configured to accommodate a secondary fuel container;
a plurality of racks, wherein the plurality of racks is removably incorporated inside the thermally insulated enclosure of the oven, wherein the plurality of racks is configured to receive the food substance;
a closable opening, wherein the closable opening corresponds to a wall of the at least one side wall, wherein the closable opening is configured to provide access to an interior of the oven in an open state, wherein the closable opening is configured to thermally insulate the thermally insulated enclosure when in a closed state;
the secondary fuel container, configured to accommodate the secondary fuel, wherein the secondary fuel container is shaped in a manner consistent with the oven base plate, wherein the secondary fuel container is configured to receive heat through a burner, wherein the secondary fuel container is configured to heat and ignite the secondary fuel, wherein the secondary fuel upon being ignited produces heat and smoke, wherein the smoke aids in the processing of the food substance; and
a chimney located on at least one side wall of the oven, wherein the chimney is configured to provide an outlet for excess heat and smoke in the oven; and
the burner, configured to produce a flame through combustion of a primary fuel and heat the secondary fuel container; and,
a primary fuel container configured to store the primary fuel, and transmit the primary fuel to the burner via a fuel transfer duct.

2. The smokeless cooking apparatus of claim 1, wherein the processing of the food substance includes at least one of heating, baking, drying, cooking, grilling, and infusing with flavor.

3. The smokeless cooking apparatus of claim 1, wherein the smokeless cooking apparatus comprises a thermostat controller, wherein the thermostat controller is connected to an exterior surface of the at least one side wall, wherein the thermostat controller is configured to regulate a temperature inside the oven, wherein the thermostat controller comprises:
a temperature bulb mounted inside the oven configured to detect a temperature in the interior of the oven;
a primary fuel input, wherein the primary fuel input comprises an inlet configured to receive the fuel transfer duct from the primary fuel container;
a primary fuel output, wherein the primary fuel output comprises an outlet duct to a fuel transfer chamber, wherein the fuel transfer chamber transfers the primary fuel to the burner via a fuel burner input duct;
an output valve connected to the primary fuel output, wherein the output valve is configured to restrict and allow the primary fuel to be transmitted to the burner from the thermostat based on a magnitude of opening of the output valve, wherein the output valve restricts transmission of the primary fuel to the burner in a completely closed state, wherein the output valve allows maximum transmission of the primary fuel to the burner in a completely open state;
a controller connected to the temperature bulb and the outlet valve, wherein the controller is configured to regulate an amount of the primary fuel transmitted to the burner from the thermostat by changing the magnitude of opening of the output valve; and
a regulator connected to the temperature bulb and the controller, wherein the regulator is configured to be manipulated by a user and adjust a temperature in the interior of the oven.

4. The smokeless cooking apparatus of claim 1, wherein the burner comprises a plurality of burners, wherein a burner of the plurality of burners is located directly beneath the secondary fuel container to heat the secondary fuel container efficiently.

5. The smokeless cooking apparatus of claim 4, wherein the primary fuel container is configured transmit the primary fuel to the plurality of burners via a plurality of fuel transfer ducts corresponding to the plurality of burners.

6. The smokeless cooking apparatus of claim 1, wherein the primary fuel comprises at least one of propane, Liquefied Petroleum Gas (LPG) including butane and isobutane, and natural gas.

7. The smokeless cooking apparatus of claim 1, wherein the secondary fuel comprises at least one of charcoal briquettes, hardwood lump charcoal, wood chips, and wood pellets.

8. The smokeless cooking apparatus of claim 1, wherein the primary fuel container is a positive pressure container configured to store the primary fuel at a positive pressure higher than atmospheric pressure to transmit the primary fuel to the burner.

9. The smokeless cooking apparatus of claim 1, wherein the closable opening includes a hinged door, wherein the hinged door is connected to the oven through a hinge, wherein the hinged door is configured to rotate around an axis of rotation coinciding with the hinge, wherein the hinged door is configured to provide access to the oven, wherein the hinged door is configured to thermally insulate the thermally insulated enclosure when in a closed state, wherein the hinged door includes a locking mechanism configured to lock the hinged door when in the closed state.

10. The smokeless cooking apparatus of claim 1, wherein the closable opening includes a sliding door, wherein the sliding door is connected to the oven and configured to be accommodated in a plurality of sliding rails built into the top wall, and the bottom panel of the oven, wherein the sliding door is configured to slide in the sliding rails, wherein the sliding door is configured to provide access to the oven, wherein the sliding door is configured to thermally insulate the thermally insulated enclosure when in a closed state.

11. The smokeless cooking apparatus of claim 1, wherein the smokeless cooking apparatus comprises a transport mechanism configured to transport the smokeless cooking apparatus including the oven, the burner, and the primary fuel container, the transport mechanism comprising:
a frame comprising a generally rectangular bottom plate, wherein the frame comprises four posts vertically extending from the four corners of the bottom plate, wherein the bottom plate provides structural stability to the frame, wherein the bottom plate is configured to support the primary fuel container, wherein each of the four posts include a support mechanism configured to support the oven,
a top plate located above the bottom plate, below the oven and supported by the four posts, wherein the top plate is parallel to the bottom plate, wherein the top plate is configured to accommodate the burner;
a plurality of wheels connected to the bottom plate, wherein the plurality of wheels is configured to allow easy movement of the transport mechanism; and
a plurality of casters connected to the bottom plate, wherein the plurality of casters is configured to allow easy turning of the transport mechanism.

12. The smokeless cooking apparatus of claim 11, wherein the transport mechanism includes a handling mechanism, wherein the handling mechanism includes a plurality of gripping members attached to the four posts, wherein the plurality of gripping members allows for easy manipulation and transport of the transport mechanism.

13. The smokeless cooking apparatus of claim 11, wherein the transport mechanism includes an engine, wherein the engine is configured to drive at least one wheel of the plurality of wheels, wherein the engine includes at least one of an electric engine, and an Internal Combustion engine.

14. The smokeless cooking apparatus of claim 1, wherein the secondary fuel container is positioned below the oven base plate and above the burner, wherein the oven base plate includes a base opening shaped consistently with a top opening of the secondary fuel container, wherein the base opening is configured to receive a top opening of the secondary fuel container to receive heat and smoke upon ignition of the secondary fuel.

15. A smokeless cooking apparatus comprising:
an oven configured for the processing of a food substance, the oven comprising:
a thermally insulated enclosure comprised of at least one side wall, and a top wall, wherein the thermally insulated enclosure is configured to trap heat for processing of a food substance;
an oven base plate configured to accommodate a secondary fuel container
a plurality of racks, wherein the plurality of racks is removably incorporated inside the thermally insulated enclosure of the oven, wherein the plurality of racks is configured to receive the food substance;
a closable opening, wherein the closable opening corresponds to a wall of the at least one side wall, wherein the closable opening is configured to provide access to an interior of the oven in an open state, wherein the closable opening is configured to thermally insulate the thermally insulated enclosure when in a closed state;
the secondary fuel container, configured to accommodate the secondary fuel, wherein the secondary fuel container is shaped in a manner consistent with the oven base plate, wherein the secondary fuel container is configured to receive heat through a plurality of burners, wherein, the secondary fuel container is configured to heat and ignited the secondary fuel, wherein the secondary fuel upon being ignited produces heat and smoke, wherein the smoke aids in the processing of the food substance;
a chimney located on at least one side wall of the oven, wherein the chimney is configured to provide an outlet for excess heat and smoke in the oven; and
the plurality of burners, configured to produce a flame through combustion of a primary fuel and heat the secondary fuel container
a primary fuel container configured to store the primary fuel, and transmit the primary fuel to the plurality of burners via a fuel input transfer duct;
a thermostat controller configured to regulate a temperature inside the oven, wherein the thermostat controller is connected to an exterior surface of the at least one side wall of the oven, wherein the thermostat controller comprises:
a temperature bulb mounted inside the oven configured to detect a temperature in the interior of the oven;
a primary fuel input, wherein the primary fuel input comprises an inlet configured to receive an input fuel transfer duct from the primary fuel container;
a primary fuel output, wherein the primary fuel output comprises an outlet duct to a fuel transfer chamber, wherein the fuel transfer chamber is configured to transfer the primary fuel to the plurality of burners through a plurality of fuel transfer ducts;
an output valve connected to the primary fuel output, wherein the output valve is configured to restrict and allow the primary fuel to be transmitted to the plurality of burners from the thermostat based on a magnitude of opening of the output valve, wherein the output valve restricts all transmission of the primary fuel to the plurality of burners in a completely closed state, wherein the output valve allows all transmission of the primary fuel to the plurality of burners in a completely open state; and
a controller connected to the temperature bulb and the outlet valve, wherein the controller is configured to regulate an amount of the primary fuel transmitted to the plurality of burners from the thermostat by changing the magnitude of opening of the output valve; and
a regulator connected to the temperature bulb and the controller, wherein the regulator is configured to be manipulated by a user and adjust a temperature in the interior of the oven; and,
a transport mechanism configured to transport the oven, the plurality of burners, and the primary fuel container, the transport mechanism comprising:
a frame, wherein the frame comprises a generally rectangular bottom plate, wherein the frame comprises four posts vertically extending from the four corners of the bottom plate, wherein the bottom plate provides structural stability to the frame, wherein the bottom plate is configured to support the primary fuel container, wherein each of the four posts includes a support mechanism configured to support the oven;
a top plate located above the bottom plate, below the oven and supported by the four posts, wherein the top plate is parallel to the bottom plate, wherein the top plate is configured to accommodate the plurality of burners;
a plurality of wheels connected to the bottom plate, wherein the plurality of wheels is configured to allow easy movement of the transport mechanism; and,
a plurality of casters connected to the bottom plate, wherein the plurality of wheels is configured to allow easy movement of the transport mechanism.

16. The smokeless cooking apparatus of claim 15, wherein the processing of the food substance includes at least one of heating, baking, drying, cooking, grilling, and infusing with flavor.

17. The smokeless cooking apparatus of claim 15, wherein the primary fuel comprises at least one of propane, Liquefied Petroleum Gas (LPG) including butane and isobutane, and natural gas.

18. The smokeless cooking apparatus of claim 15, wherein the secondary fuel comprises at least one of charcoal briquettes, hardwood lump charcoal, wood chips, and wood pellets.

19. The smokeless cooking apparatus of claim 15, wherein the primary fuel container is a positive pressure container configured to store the primary fuel at a positive pressure higher than atmospheric pressure to transmit the primary fuel to the plurality of burners.

20. The smokeless cooking apparatus of claim 15, wherein the closable opening includes a hinged door, wherein the hinged door is connected to the oven through a hinge, wherein the hinged door is configured to rotate around an axis of rotation coinciding with the hinge, wherein the hinged door is configured to provide access to the oven, wherein the hinged door is configured to thermally insulate the thermally insulated enclosure when in the closed state.
